(19) United States
(12) Patent Application Publication
(10) Pub. No.: US 2014/0286011 A1
(43) Pub. Date: Sep. 25, 2014

(54) COMBINATION SPEAKER AND LIGHT SOURCE POWERED USING LIGHT SOCKET

(71) Applicants: Michael Edward Smith Luna, San Jose, CA (US); Patrick Alan Narron, Boulder Creek, CA (US); Derek Barrentine, Gilroy, CA (US); Scott Fullam, Palo Alto, CA (US)

(72) Inventors: Michael Edward Smith Luna, San Jose, CA (US); Patrick Alan Narron, Boulder Creek, CA (US); Derek Barrentine, Gilroy, CA (US); Scott Fullam, Palo Alto, CA (US)

(73) Assignee: AliphCom, San Francisco, CA (US)

(21) Appl. No.: 14/205,263

(22) Filed: Mar. 11, 2014

Related U.S. Application Data
(60) Provisional application No. 61/786,179, filed on Mar. 14, 2013.

(51) Int. Cl. F21V 33/00; F21V 13/02; H04R 1/02

(52) U.S. Cl. CPC F21V 33/0056; H04R 1/028; F21V 13/02
USPC 362/253

(57) ABSTRACT

Techniques associated with a combination speaker and light source powered using a light socket are described, including an acoustically sealed housing, a light socket connector coupled to the housing and configured to provide power to elements within the speaker and light source system when the light socket connector is coupled with a light socket, a light source housed within the housing and configured to be powered using the light socket connector, an optical diffuser on a front end of the housing, a parabolic reflector housed within the housing, the parabolic reflector configured to reflect light from the light source toward the optical diffuser, and a speaker coupled to the housing and configured to output audio.

### CROSS-REFERENCE TO RELATED APPLICATIONS

This application claims the benefit of U.S. Provisional Patent Application No. 61/786,179 (Attorney Docket No. ALI-270P), filed Mar. 14, 2013, which is incorporated by reference herein in its entirety for all purposes.

### FIELD

The present invention relates generally to electrical and electronic hardware, electromechanical and computing devices. More specifically, techniques related to a combination speaker and light source powered using a light socket are described.

### BACKGROUND

Conventional devices for lighting typically do not provide audio playback capabilities, and conventional devices for audio playback (i.e., speakers) typically do not provide light. Although there are conventional speakers equipped with light features for decoration or as part of a user interface, such conventional speakers are typically not configured to provide ambient lighting or the light an environment. Also, conventional speakers typically are not configured to be installed into or powered using a light socket.

Thus, what is needed is a solution for a combination speaker and light source powered using a light socket without the limitations of conventional techniques.

### BRIEF DESCRIPTION OF THE DRAWINGS

Various embodiments or examples (“examples”) are disclosed in the following detailed description and the accompanying drawings:

FIG. 1 illustrates an exemplary combination speaker and light source powered using a light socket.

Although the above-described drawings depict various examples of the invention, the invention is not limited by the depicted examples. It is to be understood that, in the drawings, like reference numerals designate like structural elements. Also, it is understood that the drawings are not necessarily to scale.

### DETAILED DESCRIPTION

Various embodiments or examples may be implemented in numerous ways, including as a system, a process, an apparatus, a device, and a method associated with a wearable device structure with enhanced detection by motion sensor. In some embodiments, motion may be detected using an accelerometer that responds to an applied force and produces an output signal representative of the acceleration (and hence in some cases a velocity or displacement) produced by the force. Embodiments may be used to couple or secure a wearable device onto a body part. Techniques described are directed to systems, apparatuses, devices, and methods for using accelerometers, or other devices capable of detecting motion, to detect the motion of an element or part of an overall system. In some examples, the described techniques may be used to accurately and reliably detect the motion of a part of the human body or an element of another complex system. In general, operations of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described techniques may be practiced according to the claims without some or all of these specific details. For clarity, technical material that is known in the technical fields related to the examples has not been described in detail to avoid unnecessarily obscuring the description.

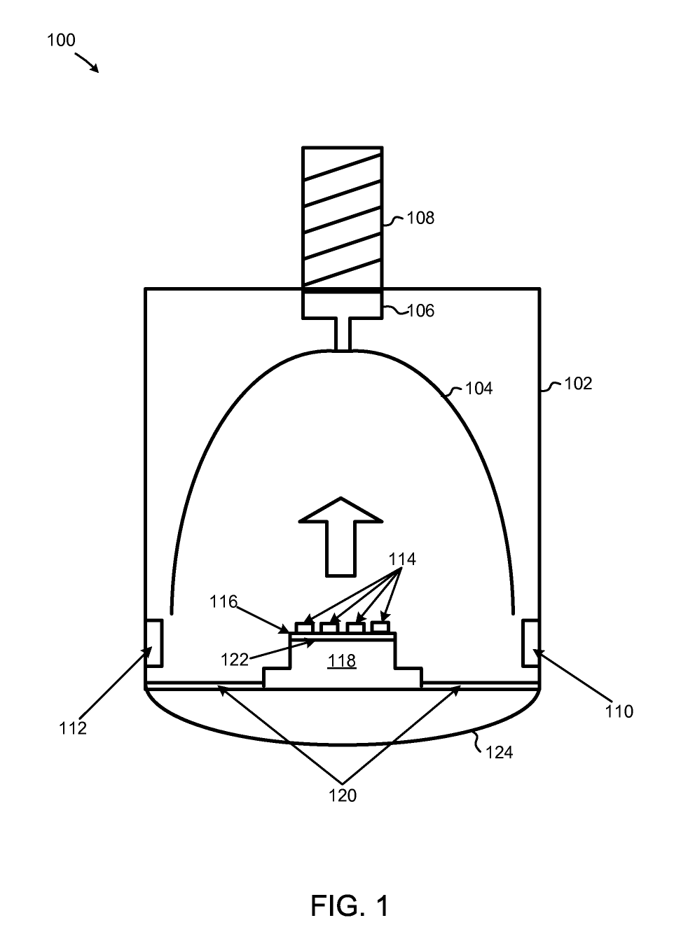

FIG. 1 illustrates an exemplary combination speaker and light source powered using a light socket. Here, device 100 includes housing 102, parabolic reflector 104, positioning mechanism 106, light socket connector 108, passive radiators 110-112, light source 114, circuit board (PCB) 116, speaker 118, frontplate 120, backplate 122 and optical diffuser 124. In some examples, device 100 may be implemented as a combination speaker and light source, including a controllable light source (i.e., light source 114) and a speaker system (i.e., speaker 118). In some examples, light source 114 may be configured to provide adjustable and controllable light, including an on or off state, varying colors, brightness, and irradiance patterns, without limitation. In some examples, light source 114 may be controlled using a controller or control interface (not shown) in data communication with light source 114 (i.e., using a communication facility implemented on PCB 116) using a wired or wireless network (e.g., power line standards (e.g., G.hn, HomePlugAV, HomePlugAV2, IEEE1901, or the like), Ethernet, WiFi (e.g., 802.11 a/b/g/n/ac, or the like), Bluetooth®, or the like). In some examples, light source 114 may be implemented using one or more light emitting diodes (LEDs) coupled to PCB 116. In other examples, light source 114 may be implemented using a different type of light source (e.g., incandescent, light emitting electrochemical cells, halogen, compact fluorescent, or the like). In some examples, PCB 116 may be bonded or otherwise mounted to backplate 122, which may be coupled to a driver (not shown) for speaker 118, to provide a heatsink for light source 114. In some examples, PCB 116 may provide a control signal to light source 114, for example, to turn light source 114 on and off, or control various characteristics associated with light source 114 (e.g., amount, amplitude, brightness, color, quality, of light, or the like). In some examples, light source 114 may direct light towards parabolic reflector 104, as shown. In some examples, parabolic reflector 104 may be configured to direct light from light source 114 towards a front of housing 102 (i.e., towards frontplate 120 and optical diffuser 124), which may be transparent. In some examples, parabolic reflector 104 may be movable (e.g., turned, rotated, shifted, repositioned, or the like) using positioning mechanism 106, either manually or electronically, for example, using a remote control in data communication with circuitry implemented in positioning mechanism 106. For example, parabolic reflector 104 may be moved to change an output light irradiation pattern. In some examples, parabolic reflector 104 may be acoustically transparent such that additional volume within housing 102 (i.e., around and outside of parabolic reflector 104) may be available for acoustic use with a passive radiation system (e.g., including passive radiators 110-112, and the like).

In some examples, light socket connector 108 may be configured to be coupled with a light socket (e.g., standard Edison screw base, as shown, bayonet mount, bi-post, bi-pin, or the like) for powering (i.e., electrically) device 100. In some examples, light socket connector 108 may be coupled to housing 102 on a side opposite to optical diffuser 124 and/or speaker 118. In some examples, housing 102 may be configured to house one or more of parabolic reflector 104, positioning mechanism 106, passive radiators 110-112, light source 114, PCB 116, speaker 118 and frontplate 120. Electronics (not shown) configured to support control, audio playback, light output, and other aspects of device 100, may be mounted anywhere inside or outside of housing 102. In some examples, light socket connector 108 may be configured to receive power from a standard light bulb or power connector socket (e.g., E26 or E27 screw style, T12 or GU4 pins style, or the like), using either or both AC and DC power. In some examples, device 100 also may be implemented with an Ethernet connection.

In some examples, speaker 118 may be suspended in the center of frontplate 120, which may be sealed. In some examples, frontplate 120 may be transparent and mounted or otherwise coupled with one or more passive radiators. In some examples, speaker 118 may be configured to be controlled (e.g., to play audio, to tune volume, or the like) remotely using a controller (not shown) in data communication with speaker 118 using a wired or wireless network. In some examples, housing 102 may be acoustically sealed to provide a resonant cavity when combined with passive radiators 110-112 (or other passive radiators, for example, disposed on frontplate 120 (not shown). In other examples, radiators 110-112 may be disposed on a different internal surface of housing 102 than shown. The combination of an acoustically sealed housing 102 with one or more passive radiators (e.g., passive radiators 110-112) improves low frequency audio signal reproduction, while optical diffuser 124 may be acoustically transparent, thus sound from speaker 118 may be projected out of a front end of housing 102 through optical diffuser 124. In some examples, optical diffuser 124 may be configured to be waterproof (e.g., using a seal, chemical waterproofing material, and the like). In some examples, optical diffuser 124 may be configured to spread light (i.e., reflected using parabolic reflector 104) evenly as light exits housing 102 through a transparent frontplate 120. In some examples, optical diffuser 124 may be configured to be acoustically transparent in a frequency selective manner (i.e., acoustically transparent, or designed to not impede sound waves, in certain selected frequencies), functioning as an additional acoustic chamber volume (i.e., forming an acoustic chamber volume with a front end of housing 102, as defined by frontplate 120, as part of a passive radiator system including housing 102, radiators 110-112, and other components of device 100). In other examples, the quantity, type, function, structure, and configuration of the elements shown may be varied and are not limited to the examples provided.

Although the foregoing examples have been described in some detail for purposes of clarity of understanding, the above-described inventive techniques are not limited to the details provided. There are many alternative ways of implementing the above-described invention techniques. The disclosed examples are illustrative and not restrictive.

What is claimed:

1. A system, comprising:
a housing being acoustically sealed;
a light socket connector coupled to the housing and configured to provide power to one or more elements associated with the system when the light socket connector is coupled with a light socket;
a light source disposed within the housing and configured to be powered using the light socket connector;
an optical diffuser disposed on a front end of the housing;
a parabolic reflector disposed within the housing, the parabolic reflector configured to reflect light from the light source toward the optical diffuser; and
a speaker coupled to the housing and configured to output audio.

2. The system of claim 1, further comprising one or more passive radiators coupled to an interior surface of the housing, the housing and the one or more passive radiators forming a passive radiation system.

3. The system of claim 1, wherein the housing comprises a transparent frontplate at the front end.

4. The system of claim 3, further comprising one or more passive radiators disposed on the transparent frontplate.

5. The system of claim 1, further comprising a positioning mechanism configured to move the parabolic reflector.

6. The system of claim 5, wherein the positioning mechanism is configured to change a light output using a movement of the parabolic reflector.

7. The system of claim 1, wherein the light source comprises one or more light emitting diodes.

8. The system of claim 1, wherein the speaker comprises a speaker driver having a backplate.

9. The system of claim 8, further comprising a circuit board mounted to the backplate, the circuit board configured to provide a control signal to the light source.

10. The system of claim 8, wherein the backplate is configured to provide a heatsink.

11. The system of claim 1, wherein the speaker is configured to communicate wirelessly with a controller.

12. The system of claim 1, wherein the light source is configured to communicate wirelessly with a controller.

13. The system of claim 1, wherein the optical diffuser is configured to spread light reflected off of the parabolic reflector.

14. The system of claim 1, wherein the optical diffuser is configured to be acoustically transparent in a frequency selective manner.

15. The system of claim 1, wherein the optical diffuser is configured to form an acoustic chamber volume with the front end of the housing.
